(19) United States
(12) Patent Application Publication
(10) Pub. No.: US 2019/0286074 A1
(43) Pub. Date: Sep. 19, 2019

(54) SPARSE ASSOCIATIVE MEMORY FOR IDENTIFICATION OF OBJECTS

(71) Applicant: HRL Laboratories, LLC, Malibu, CA (US)

(72) Inventor: Heiko Hoffmann, Simi Valley, CA (US)

(21) Appl. No.: 16/297,449

(22) Filed: Mar. 8, 2019

Related U.S. Application Data
(60) Provisional application No. 62/642,521, filed on Mar. 13, 2018.

(51) Int. Cl. G05B 13/02; G06N 3/04; G06K 9/62

(52) U.S. Cl. CPC G05B 13/027; G06N 3/08; G06K 9/6201; G06N 3/0445

(57) ABSTRACT

Described is a system for object identification using sparse associative memory. In operation, the system converts signature data regarding an object into a set of binary signals representing activations in a layer of input neurons. The input neurons are connected to hidden neurons based on the activations in the layer of input neurons, which allows for recurrent connections to be formed from hidden neurons back onto the input neurons. An activation pattern of the input neurons is then identified upon stabilization of the input neurons in the layer of input neurons. The activation pattern is a restored pattern, which allows the system to identify the object by comparing the restored pattern against stored patterns in a relational database. Based upon the object identification, a device, such as a robotic arm, etc., can then be controlled.

### CROSS-REFERENCE TO RELATED APPLICATIONS

This application claims the benefit of and is a non-provisional patent application of U.S. Provisional Application No. 62/642,521, filed on Mar. 13, 2018, the entirety of which is hereby incorporated by reference.

### BACKGROUND OF INVENTION

### (1) Field of Invention

The present invention relates to an object recognition system and, more specifically, to an object recognition system using sparse associative memory (SAM) for identification of objects.

### (2) Description of Related Art

The ability to automatically identify particular objects can be important in a variety of settings. For example, it is important to be able to quickly identify machinery or parts for forensics or verification purposes. Parts in military systems might be fake and, thus, verification is required to test if a part is indeed a particular object, or even a particular object from a selected and approved supplier. Verification by manual means is too time-consuming and, so, automatic means are required.

Attempts have been made to create recognition systems using neural networks. For example, some researchers have attempted to employ variations of the Hopfield network (see the List of Incorporated Literature References, Literature Reference No. 6), which is an associative memory. A Hopfield network is a fully connected network (i.e., each neuron is connected to every other neuron), and patterns are stored in the weights of the connections between the neurons. While somewhat operable for identifying patterns, a Hopfield network has several disadvantages, including:
1. Storing the weights requires a lot of computer memory space because they are floating point and number O(n²), where n is the number of neurons.
2. The recall of memories is not limited to the patterns stored in the network; in addition, so-called spurious memories are frequently recalled by the network (see Literature Reference No. 1). For a sufficiently large number of stored patterns, the recall probability of a spurious memory is close to 100% when the network is presented with a random input.
3. The probability of correct retrieval drops to near 0% for even a modest number of stored patterns, limiting the number of patterns that can be stored by the network; the number of stored patterns is upper bounded by n/(2 log n), e.g., 72 for n=1000 neurons (see Literature Reference No. 2).

Variants of the Hopfield network provide different rules on how to update the connection weights. With some of those rules, the capacity for storing patterns could be larger than stated above. For example, with Storkey's rule, the capacity is n/sqrt(2 log n) instead of n/(2 log n), e.g., 269 for n=1000 neurons (see Literature Reference No. 9). Still, the disadvantages 1 and 2 above persist.

Thus, a continuing need exists for a system that automatically and efficiently detects objects using sparse associative memory.

### SUMMARY OF INVENTION

This disclosure provides a system for object identification using sparse associative memory. In various aspects, the system includes one or more processors and a memory. The memory is a non-transitory computer-readable medium having executable instructions encoded thereon, such that upon execution of the instructions, the one or more processors perform several operations, including converting signature data regarding an object into a set of binary signals representing activations in a layer of input neurons; connecting the input neurons to hidden neurons based on the activations in the layer of input neurons; forming recurrent connections from hidden neurons back onto the input neurons; identifying an activation pattern of the input neurons upon stabilization of the input neurons in the layer of input neurons, the activation pattern being a restored pattern; identifying the object by comparing the restored pattern against stored patterns in a relational database; and controlling a device based on the identification of the object.

In yet another aspect, controlling the device includes causing the device to perform a physical action based on the identification of the object.

In another aspect, the system performs an operation of iteratively activating input neurons and hidden neurons until stabilization of the input neurons occurs.

Further, stabilization of the input neurons occurs when activations remain unchanged between two consecutive time steps or a predetermined number of iterations is performed.

In yet another aspect, the recurrent connections include inhibitory connections.

In another aspect, the signature data includes sensor recordings of the object from one or more sensors.

In yet another aspect, the physical action includes causing a machine to print an object label on the object.

In another aspect, the physical action includes causing a machine to move the object into a bin.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is a flow chart illustrating a top-level process flow according to various embodiments of the present invention;

FIG. 4 is an illustration depicting architecture of associative memory according to various embodiments of the present invention;

FIG. 5 is a flow chart illustrating a process for storing one pattern according to various embodiments of the present invention;

FIG. 6 is an illustration depicting associative memory connections according to various embodiments of the present invention;

FIG. 7 is an illustration depicting associative memory connections, including inhibitory connections, according to various embodiments of the present invention;

FIG. 8 is a flow chart illustrating a process for recalling a pattern according to various embodiments of the present invention;

FIG. 9A is a graph illustrating a probability of correct pattern recall comparing SAM with inhibition and without inhibition against a Hopfield network, showing results as function of number of stored pattern when n=1000;

FIG. 9B is a graph illustrating a probability of correct pattern recall comparing SAM with inhibition and without inhibition against a Hopfield network, showing results as function of n when storing 1000 patterns;

FIG. 10A is a graph illustrating a probability of spurious activations comparing SAM with inhibition and without inhibition against a Hopfield network, showing results as function of number of stored pattern when n=1000;

FIG. 10B is a graph illustrating a probability of spurious activations comparing SAM with inhibition and without inhibition against a Hopfield network, showing results as function of n when storing 1000 patterns; and

FIG. 11 is a block diagram depicting control of a device according to various embodiments.

### DETAILED DESCRIPTION

The present invention relates to an object recognition system and, more specifically, to an object recognition system using sparse associated memory for identification of objects. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.
(1) List of Incorporated Literature References

The following references are cited throughout this application. For clarity and convenience, the references are listed herein as a central resource for the reader. The following references are hereby incorporated by reference as though fully set forth herein. The references are cited in the application by referring to the corresponding literature reference number, as follows:
1. Bruck, J., and Roychowdhury, V. P. On the number of spurious memories in the Hopfield model. IEEE Transactions on Information Theory, 36(2), 393-397, 1990.
2. McEliece, R. J., Posner, E. C., Rodemich, E. R., and Venkatesh, S. S. The capacity of the Hopfield associative memory, IEEE Transactions on Information Theory, 33(4), 461-482, 1987.
3. Hoffmann, H., Schenck, W., and Moller, R. Learning visuomotor transformations for gaze-control and grasping. Biological Cybernetics, 93, 119-130, 2005.
4. Hoffmann, H., Howard, M., and Daily, M. Fast pattern matching with time-delay neural networks. International Joint Conference on Neural Networks, 2011.
5. Hoffmann, H. Neural network device with engineered delays for pattern storage and matching. U.S. Pat. No. 8,818,923, Aug. 26, 2014.
6. Hopfield, J. J. Neural networks and physical systems with emergent collective computational abilities. Proceedings of the National Academy of Sciences of the USA, 79, 2554-2558, 1982.
7. Lowel, S. and Singer, W. Selection of intrinsic horizontal connections in the visual cortex by correlated neuronal activity. Science, 255, Issue 5041, 209-212, 1992.
8. Minkovich K., Srinivasa, N., Cruz-Albrecht, J. M., Cho, Y. K., and Nogin, A. Programming Time-Multiplexed Reconfigurable Hardware Using a Scalable Neuromorphic Compiler. IEEE Trans. on Neural Networks and Learning Systems, 23 (6), 889-901, 2012.
9. Storkey, A. Increasing the capacity of a Hopfield network without sacrificing functionality. Artificial Neural Networks—ICANN'97, 451-456, 1997.

### (2) Principal Aspects

Various embodiments of the invention include three “principal” aspects. The first is a system for object identification using sparse associated memory. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

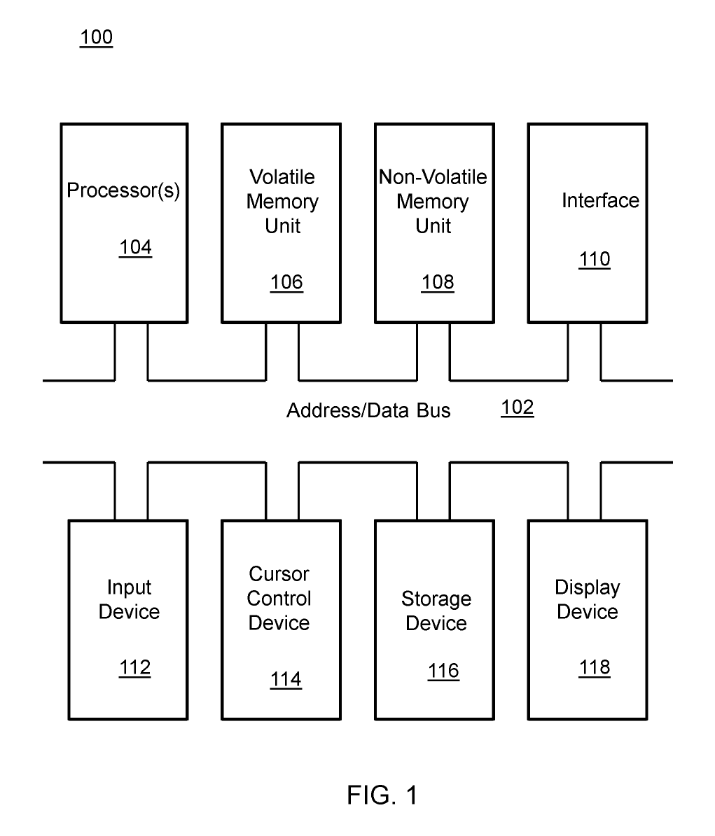

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

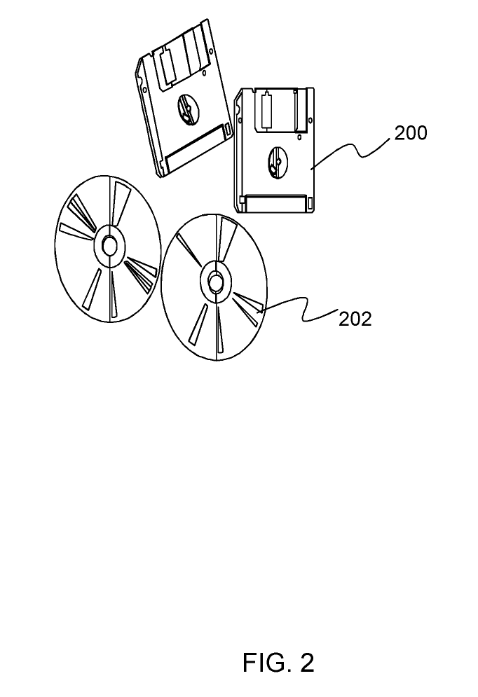

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (3) Introduction

This disclosure provides a system and method to identify objects through the use of an associative memory, which learns a signature of an object. This signature might be an audio signal and/or image recorded from the object. A signature is, for example, the light absorption over frequency diagram for a surface material, or the sound recording when scratching the surface with a robotic finger, or a combination of both. These signatures have to be chosen such that they can uniquely identify the object as being made by a specific manufacturer. The system employs a unique associative memory and a unique means to train the associative memory. The associative memory includes a layer of input neurons and a layer of hidden neurons and sparse connections between the two layers. The hidden neurons project recursively back onto the input neurons. This network restores partially complete or noisy patterns to their original states, which were previously stored in the network. These restored patterns are then used to retrieve an object label, which is then associated with the object. For example, upon retrieving the object label, the system causes the object label to be printed onto the object, e.g., with a laser printer.

As can be appreciated by those skilled in the art, the system described herein can be applied to a variety of applications. As a non-limiting example, the system can be implemented to identify machinery or parts, e.g., for forensics or verification. In some aspects, the system can be implemented to identify whether an object under consideration is a particular desired object, such as an engine block versus a cabbage. However, in other aspects, identification implies verifying if a part has been made to specifications or is perhaps a counterfeit. Parts in military systems might be fake and, thus, verification is required to test if a part is indeed from the selected supplier. An advantage of the invention is that it uses an associative memory that can restore noisy or partially complete data patterns to their original state. The original state can then be used in a relational database to retrieve the object ID. Different from other related associative-memory systems, the system of this disclosure greatly reduces the recall of spurious memories, which are ghost memories that have not been learned by the system. Moreover, capacity and efficiency measures are superior compared to other associative memories.

### (4) Specific Details of Various Embodiments

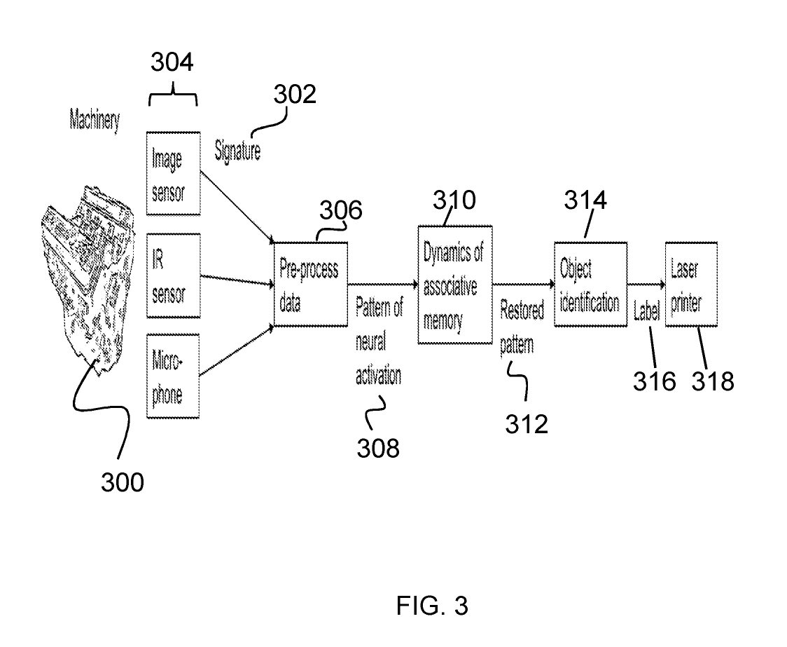

As noted above and as depicted in FIG. 3, the system of the present disclosure can be used to identity objects 300 (e.g., machinery or parts of machinery, etc.) based on a characteristic signature 302 of the object 300. This signature 302 may be obtained as data from one or more sensors 304, such as image, IR, and/or audio data. The signature 302 is not limited to these data and may include also side-channel data. A non-limiting example of such side-channel data includes the voltage time-series of the electric supply to the object or machinery. As a preparatory step, signatures of known objects are stored in a database for later use For identification, a new signature of an object is presented, which is processed 306 to generate neural activation patterns 308 using, for example, a neural network with Gaussian activations functions (tuning curves as described below) to map the input data provided in several real-valued variables onto binary neural activation patterns. Associative memory 310 then restores the corresponding neural activation pattern as a restored pattern 312. Here, restoring completes a noisy or partially complete pattern (pattern completion or restoration is described in the following paragraphs) and makes a new input pattern match with a stored signature if it is sufficiently close. If an incomplete pattern can be restored/completed by the associative memory such that it matches exactly a stored pattern, then it was sufficiently close. For example, in the tests against the Hopfield network (as described below), the activation of 5 neurons out of 1000 was changed (i.e., incomplete pattern); this change was sufficiently close to allow pattern completion. This restoration is necessary because the signature 302 may vary from stored signatures due to noise. Subsequently, the object ID 314 can be retrieved from the restored pattern 312 in a relational database. This object ID 314 can then be used for an associated physical action. For example, the object ID 314 can printed as a label 316 by a laser printer 318 onto the object 300. Alternatively, a robot arm may move (e.g., push or grasp, lift, and drop, etc.) an object 300 with a mismatched ID into a bin for disposal.

Before the associative memory 310 can operate on signatures 302, the signatures 302 have to be pre-processed 306 into binary patterns, e.g., arrays of zeros and ones. To convert a continuous signal into an array of binary numbers, as a non-limiting example, tuning curves could be used. Tuning curves were described, for example, in Literature Reference No. 3. In that work, each binary number represents a neuron with a receptive field, which is implemented as a Gaussian filter: the neuron responds with highest probability to a signal of a certain set value, and the probability of response decreases if the signal value deviates from the set value. In this example, the Gaussian function defines the probability (between 0 and 1) at which the binary value is set to 1 (otherwise 0). As a result, a signature 302 is converted into an activation pattern 308 in a pool of input neurons that belong to the associative memory.

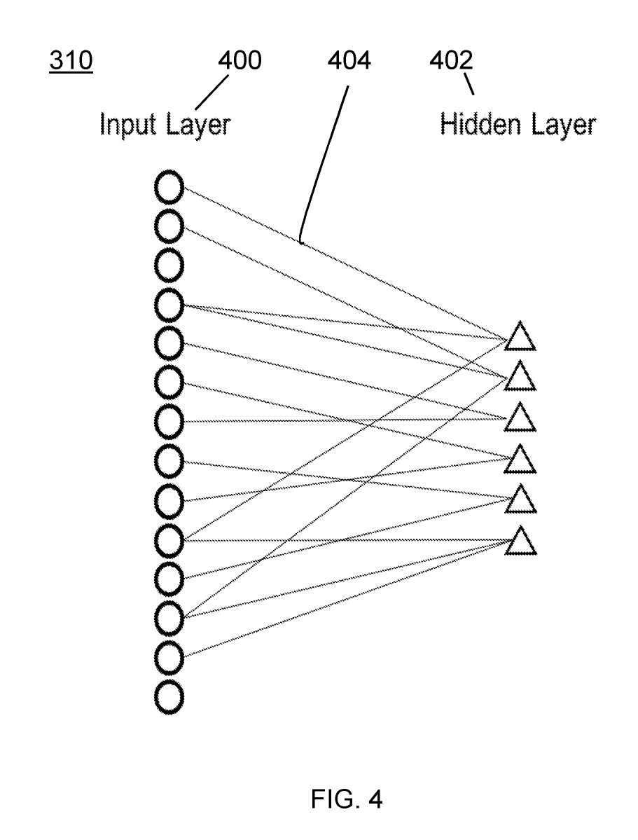

As shown in FIG. 4, the associative memory 310 consists of an input layer 400 of neurons (e.g., n=14 in the example depicted in FIG. 4), a layer of hidden neurons 402, and connections 404 between the two layers. The system operates in two modes: training and recall.

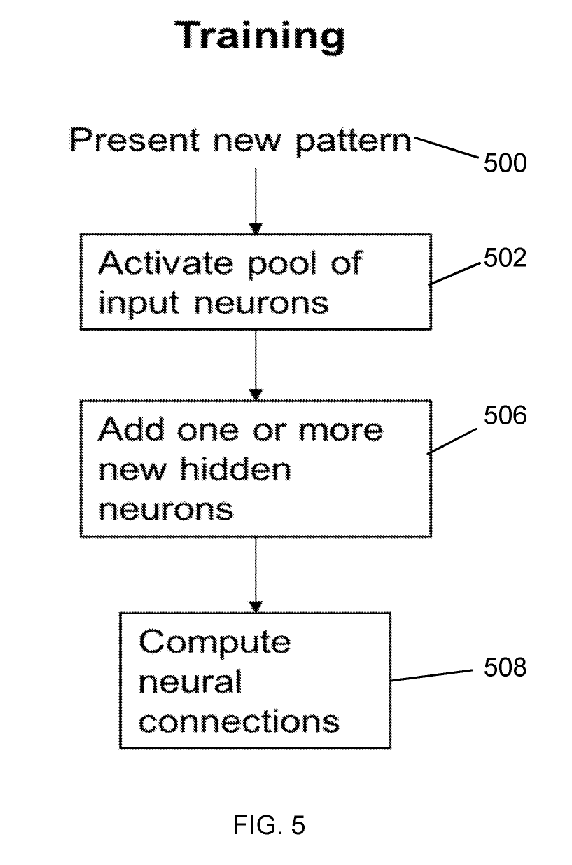

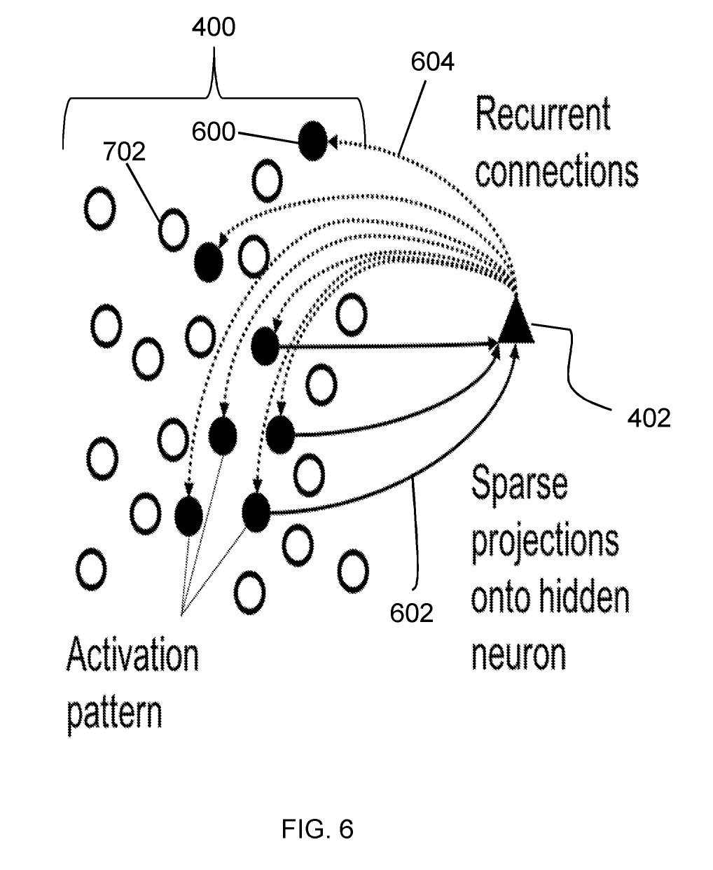

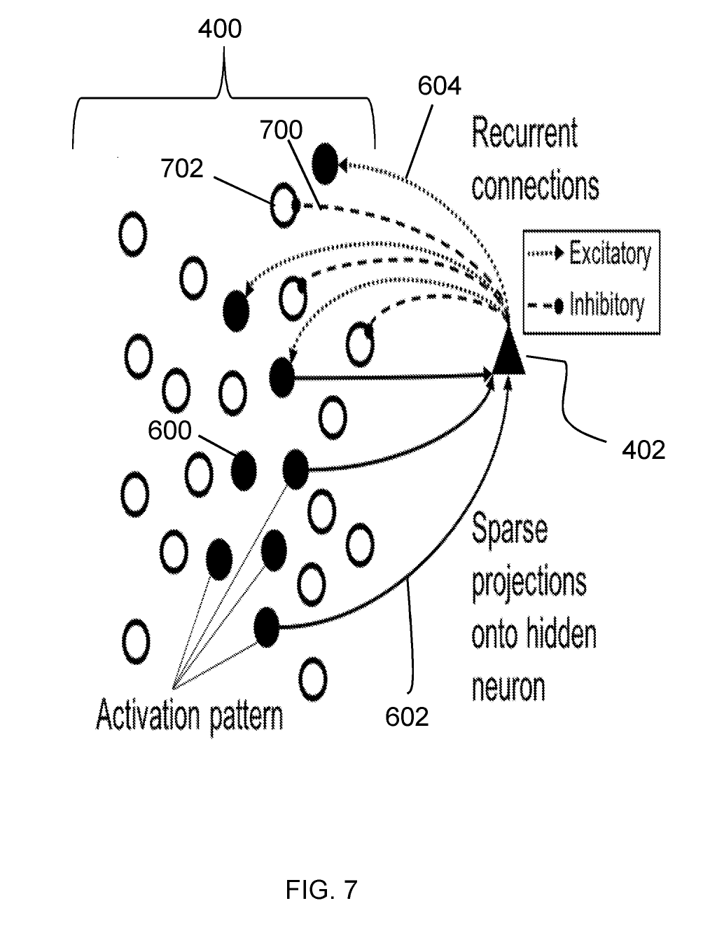

Initially, before any training, the memory has an input layer 400 of n neurons, but no hidden neurons and no connections. In training and as shown in FIG. 5, patterns are stored one at a time. First, a new pattern is presented 500, which activates 502 a pool of input neurons. To store a pattern, a set of h hidden neurons is created 506 by allocating memory for the activation of these neurons. Then, neural connections are formed (computed) 508 between the input layer 502 and the hidden neurons 506. For further understanding, FIGS. 6 and 7 show two variations of generating associative memory connections. For example, FIG. 6 illustrates a desired process of forming the associative memory connections; while FIG. 7 depicts an alternative aspect of forming the associative memory connections which include inhibitory connections.

As shown in the figures, the binary pattern to be stored activates a subset 600 of the input layer neurons 400 as activated neurons 600 in an activation pattern. In FIG. 6, the actived neurons 600 are indicated as solid circles, while inactive neurons 702 are indicated as open circles. Connections between the subset activated neurons 600 and hidden layer 402 are formed probabilistically. With a given probability, p_{S}, e.g., p_{S}=0.1, a directed connection is formed from an active neuron 600 in the input layer 400 to a hidden neuron 402: for each pair of active neuron and element in the set of h hidden neurons, a connection 602 is formed if a uniform random number in the interval [0,1) is smaller than p_{S}. This formation of connections is a form of Hebbian learning—neurons wire together if they fire together. See Literature Reference No. 7 for a discussion of Hebbian learning. A second set of connections 604 is created that projects from the hidden neurons 402 back onto the input neurons 400; each hidden neuron 402 assigned to the stored pattern projects to each active neuron. For the next training pattern, a new set of h hidden neurons is created, and connections are formed as described above.

In one embodiment, the projections from the hidden neurons 402 are only excitatory and connect only to the actived neurons 600 in the input layer 402 (as shown in FIG. 6). In another embodiment and as shown in FIG. 7, additional inhibitory connections 700 are formed between the hidden neurons 402 and the inactive input neurons 702 in the input layer 400. Here, a hidden neuron 402 may project to all inactive input neurons 702 or only to a subset of these neurons. This subset could again be chosen probabilistically: i.e., a connection is formed with a given probability, p_{I}, as above, but the value of this probability might be different from p_{S}, e.g., p_{I}=0.5. In yet another example embodiment, both excitatory and inhibitory connections projecting onto the input layer are chosen probabilistically.

Preferably, p_{S} is much smaller than 1, meaning that the connectivity in the network will be sparse. As such, this network is referred to as sparse associative memory (SAM). The number of neurons in the input layer should be sufficiently large, preferably, larger than the number of training patterns to be stored.

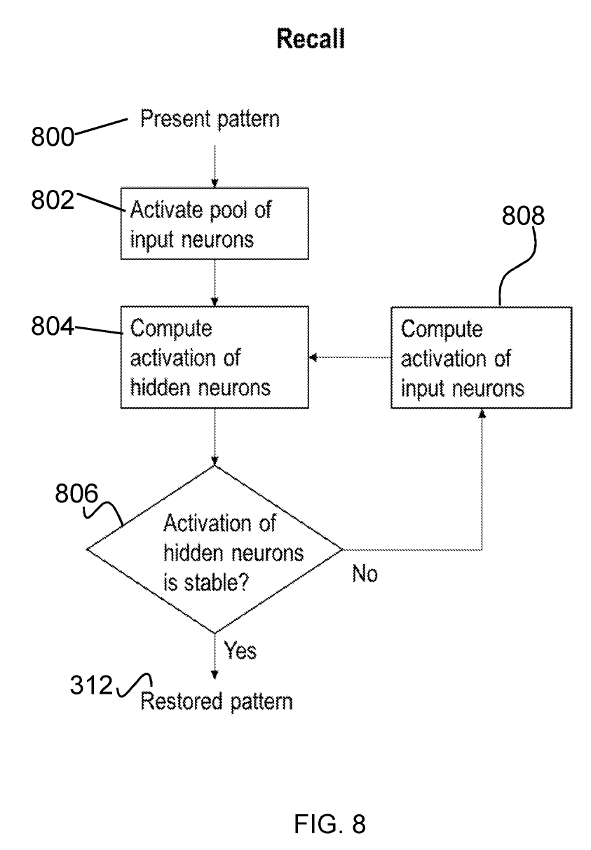

In recall and as shown in FIG. 8, a pattern 800 is presented to the input neurons which are activated accordingly 802. The corresponding hidden neurons are computed 804. It is then determined 806 if the hidden neurons are stable (described in further detail below). The associative memory iterates the activations 808 of the input neurons until a stable pattern emerges, at which point the restored pattern 312 is generated and used for identification. The neural dynamics are modeled as simple integrate and fire neurons: If a neuron fires, it sends a spike with value +1 through all its outgoing connections. An example of such simple integrate and fire neurons was described in Literature Reference Nos. 4 and 5. An inhibitory connection multiplies this value by −1. At the receiving neuron, all incoming spike values are added together; if the sum is above a predetermined threshold, then the receiving neuron becomes active and fires. Non-limiting examples of threshold values are 6 for the hidden neurons and 1 for the input neurons.

An example of a mechanism to check if the neural activation is stable is to compare activations between two consecutive time steps. If all activations remain unchanged between these steps, then the pattern is stable and the iteration stops. Alternatively, the iteration stops after a predetermined number of steps (e.g., 5). This limit on the iterations may also be used in combination with the mechanism that detects changes in activation. Once the neural activation is stable, the resulting activation pattern of the input neurons forms the restored pattern of the associative memory. For object identification, this restored pattern is compared against other patterns (of the same kind) in a relational database. In the relational database, there is a one-to-one correspondence between stored patterns and object IDs.

For efficient implementation in Random Access Memory (RAM), the input neurons form a block in RAM and have binary states. Projections onto hidden neurons can be computed with an AND operation between the RAM block and an equally-sized binary array (encoding the connections to a hidden neuron) and summing all ones in the resulting array to determine if a hidden neuron becomes active. Alternatively, neuromorphic hardware could be used to exploit the sparsity in the connectivity. Here, a physical link (wire) connects an input neuron with a hidden neuron. Preferably, reconfigurable hardware is used that allows programming these links into the neuromorphic chip (see Literature Reference No. 8 for a description of using such reconfigurable hardware and a neuromorphic chip).

The system of this disclosure is more efficient at storing patterns than a fully-connected Hopfield network. The efficiency, e, of a network is the size, n, of a binary array to be stored divided by the number of bits required for storage. For each pattern that activates a subset of m input neurons, the SAM process needs m*h*ps forward and n*h backward connections (when including the inhibitory connections). To encode each forward connection, we need log₂ n+log₂ h bits to identify the connecting neurons. For the backward connections, we need a n×h binary matrix with entries +1 or −1. As a result, our efficiency is η=n/(m*h*ps*(log₂ n+log₂ h)+n*h). In contrast, for a Hopfield network, 4*n*(n−1) bits are needed to store patterns, assuming 8 bits are sufficient to store a connection weight (usually, more bits are required since floating point numbers are used). The total number of bits is independent of the number of stored patterns, but storage is limited. To compare against the efficiency of the present invention, as many patterns were stored as the upper limit for the Hopfield network, n/(2 log n). With this number, the efficiency of the Hopfield network is e_{H}=n/(8*(n−1)*log n). As a result, the efficiency of the network decreases with the size of the network, while the efficiency of the network of the present disclosure is constant in the limit of increasing network size (even with Storkey's rule, the efficiency of the Hopfield network approaches 0 with increasing n).

As an example to compare the efficiency, 303 patterns were stored in a Hopfield network with n=2000 input neurons (2000/(2 log 2000)≈132). Each pattern activated m=200 neurons. Then, the efficiency of the Hopfield network is e_{H}=0.0165. In contrast, for the network according to the present disclosure, e=0.447 was obtained, using n=2000, m=200, h=2, p_{S}=0.1, and p_{I}=1. This value is larger by a factor of about 27. Using Storkey's rule, one could store 513 patterns in the Hopfield network with n=2000, and the efficiency improves to e_{H}=0.064, which is still a factor of about 7 smaller than the results provided by the present disclosure.

### (4.1) Experimental Results

The sparse associative memory was tested to demonstrate a marked improvement over state-of-the-art systems. In simulation, the ability to store patterns and recall such patterns was tested. The SAM used the following parameters: probability to connect input with hidden neurons, p_{S}=0.1, number of hidden neurons per pattern, h=2, threshold to activate hidden neurons: 6, and threshold to activate input neurons: 1. Two variants were tested, one without inhibition, p_{I}=0, and one with inhibition, p_{I}=1. These networks were compared against a Hopfield network, as implemented by the MATLAB Neural Networks toolbox (version R2015b).

In the first experiment, the network size was kept at n=1000 neurons, and the number of stored patterns varied from 100 to 1000 in steps of 100. In the second experiment, the number of stored patterns was 1000, and the size of the network varied from n=1000 to 2000 in steps of 100. In both experiments, each pattern activated 100 neurons, which were chosen randomly for each stored pattern. The ability to correctly retrieve patterns and the probability to recall spurious memories was tested. To test pattern retrieval, each stored pattern was presented as a test pattern with five of its bits flipped. These five bits were chosen at random. The retrieval was deemed correct if the recalled pattern matched exactly the stored pattern.

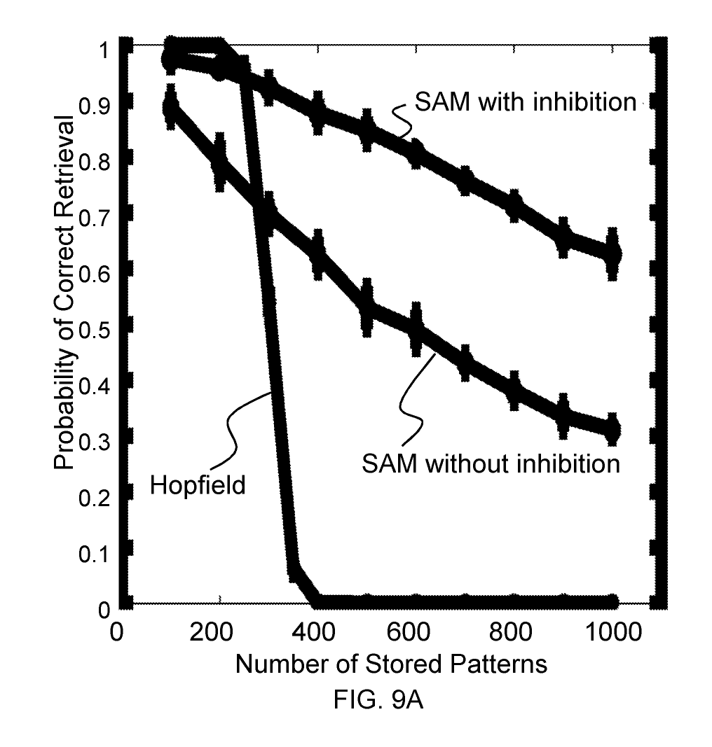

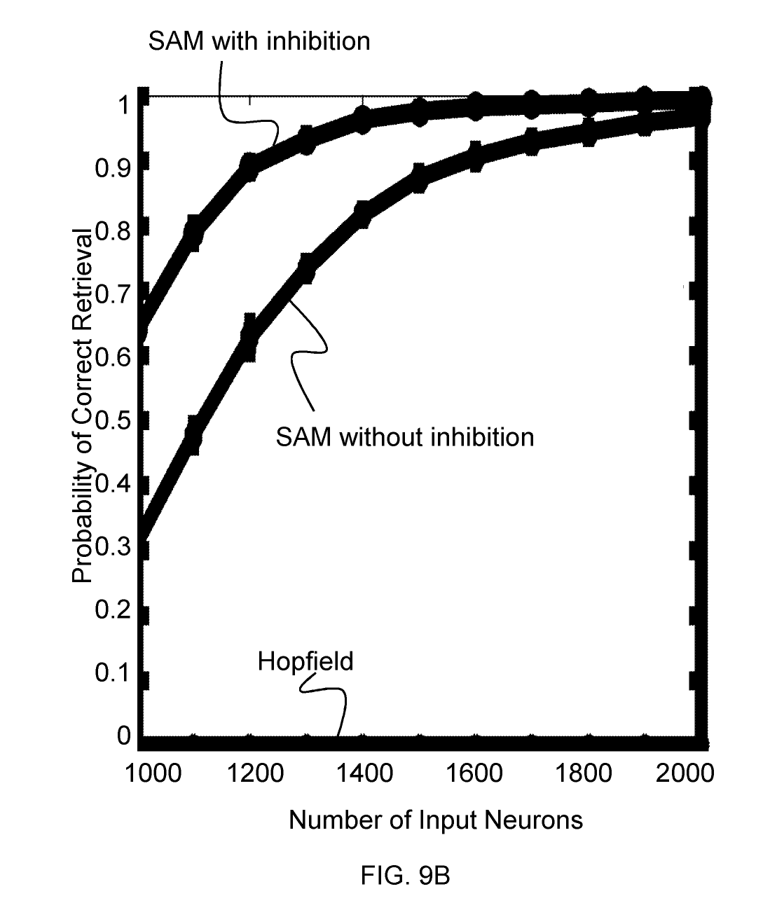

FIGS. 9A and 9B illustrate the retrieval results. Specifically, FIG. 9A is a graph illustrating a probability of correct pattern recall comparing SAM with inhibition and without inhibition against a Hopfield network, showing results as a function of the number of stored pattern when n=1000. FIG. 9B is a similar graph, showing results as function of n when storing 1000 patterns. For a sufficiently large number of neurons both variants of the invention had near perfect retrieval, while the Hopfield network needed a lot more neurons to deal with a large number of stored patterns. For the present invention, the performance was better with inhibition than without.

To test for spurious memories, random patterns were presented to the networks. Each random pattern activated 100 neurons (chosen at random). The probability that a random pattern matched a stored pattern was extremely small, <10⁻¹⁰⁰. In response to a random pattern, if a network recalled a pattern that did not match any of the stored patterns, this activation was counted as a spurious activation.

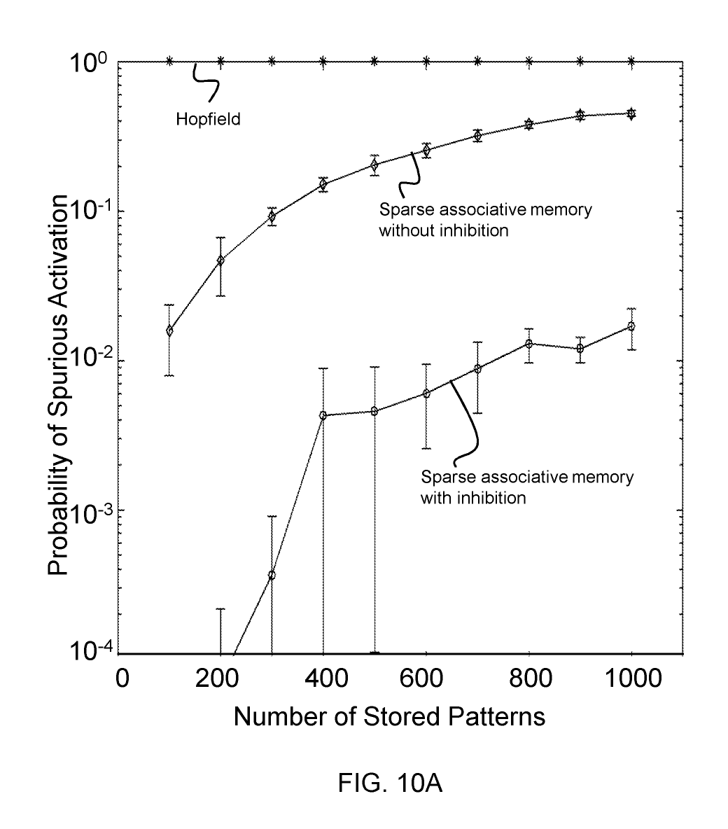

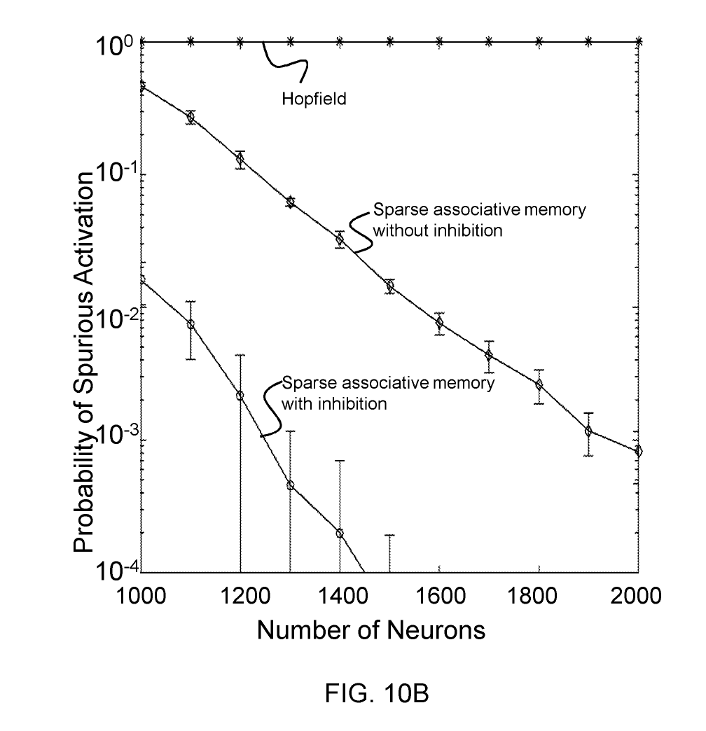

FIGS. 10A and 10B show the results for the probability of spurious activations. Specifically, FIG. 10A is a graph illustrating a probability of spurious activations comparing SAM with inhibition and without inhibition against a Hopfield network, showing results as function of number of stored pattern when n=1000. FIG. 10B is a similar graph, showing results as function of n when storing 1000 patterns. In both experiments, the Hopfield network recalled a spurious memory for 100% of test patterns. In contrast, using SAM, the probability of spurious activations was low when the number of neurons n was large compared to the number of stored pattern, e.g., the probability was <10⁻⁴ when storing 200 patterns in a network with 1000 input neurons. As for retrieval, the SAM with inhibition showed a better performance than without inhibition.

### (4.2) Control of a Device

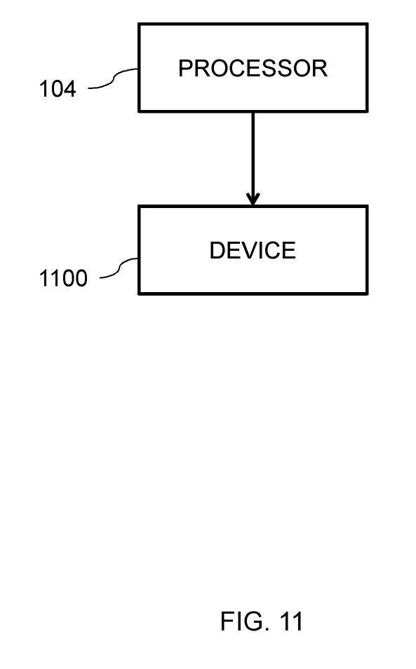

As shown in FIG. 11, a processor 104 may be used to control a device 1100 (e.g., printer, robotic arm, etc.) based on identifying the object. For example, the device 1100 may be controlled to cause the device to move or otherwise initiate a physical action based on the identification. As noted above, a machine, e.g., a laser printer, may be activated and caused to print a label on an identified object. As another example, a machine, e.g., a robot arm, may be actuated to cause the machine to move an object with a mismatched ID into a bin for disposal. As yet another example, a door or locking mechanism may be opened to give access to a room or compartment based on the identification.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for object identification using sparse associative memory, the system comprising:
one or more processors and a memory, the memory being a non-transitory computer-readable medium having executable instructions encoded thereon, such that upon execution of the instructions, the one or more processors perform operations of:
converting signature data regarding an object into a set of binary signals representing activations in a layer of input neurons;
connecting the input neurons to hidden neurons based on the activations in the layer of input neurons;
forming recurrent connections from hidden neurons back onto the input neurons;
identifying an activation pattern of the input neurons upon stabilization of the input neurons in the layer of input neurons, the activation pattern being a restored pattern;
identifying the object by comparing the restored pattern against stored patterns in a relational database; and
controlling a device based on the identification of the object.

2. The system as set forth in claim 1, wherein controlling the device includes causing the device to perform a physical action based on the identification of the object.

3. The system as set forth in claim 2 wherein the physical action includes causing a machine to print an object label on the object.

4. The system as set forth in claim 2 wherein the physical action includes causing a machine to move the object into a bin.

5. The system as set forth in claim 1, further comprising an operation of iteratively activating input neurons and hidden neurons until stabilization of the input neurons occurs.

6. The system as set forth in claim 5, wherein stabilization of the input neurons occurs when activations remain unchanged between two consecutive time steps or a predetermined number of iterations is performed.

7. The system as set forth in claim 1, wherein the recurrent connections include inhibitory connections.

8. The system as set forth in claim 1, wherein the signature data includes sensor recordings of the object from one or more sensors.

9. A computer program product for object identification using sparse associative memory. the computer program product comprising:
a non-transitory computer-readable medium having executable instructions encoded thereon, such that upon execution of the instructions by one or more processors, the one or more processors perform operations of:
converting signature data regarding an object into a set of binary signals representing activations in a layer of input neurons;
connecting the input neurons to hidden neurons based on the activations in the layer of input neurons;
forming recurrent connections from hidden neurons back onto the input neurons;
identifying an activation pattern of the input neurons upon stabilization of the input neurons in the layer of input neurons, the activation pattern being a restored pattern;
identifying the object by comparing the restored pattern against stored patterns in a relational database; and
controlling a device based on the identification of the object.

10. The computer program product as set forth in claim 9, wherein controlling the device includes causing the device to perform a physical action based on the identification of the object.

11. The computer program product as set forth in claim 10, wherein the physical action includes causing a machine to print an object label on the object.

12. The computer program product as set forth in claim 10, wherein the physical action includes causing a machine to move the object into a bin.

13. The computer program product as set forth in claim 9, further comprising instructions for causing the one or more processors to perform an operation of iteratively activating input neurons and hidden neurons until stabilization of the input neurons occurs.

14. The computer program product as set forth in claim 13, wherein stabilization of the input neurons occurs when activations remain unchanged between two consecutive time steps or a predetermined number of iterations is performed.

15. The computer program product as set forth in claim 9, wherein the recurrent connections include inhibitory connections.

16. The computer program product as set forth in claim 9, wherein the signature data includes sensor recordings of the object from one or more sensors.

17. A computer implemented method for object identification using sparse associative memory, the method comprising an act of:
causing one or more processers to execute instructions encoded on a non-transitory computer-readable medium, such that upon execution, the one or more processors perform operations of:
converting signature data regarding an object into a set of binary signals representing activations in a layer of input neurons;
connecting the input neurons to hidden neurons based on the activations in the layer of input neurons;
forming recurrent connections from hidden neurons back onto the input neurons;
identifying an activation pattern of the input neurons upon stabilization of the input neurons in the layer of input neurons, the activation pattern being a restored pattern;
identifying the object by comparing the restored pattern against stored patterns in a relational database; and
controlling a device based on the identification of the object.

18. The method as set forth in claim 17, wherein controlling the device includes causing the device to perform a physical action based on the identification of the object.

19. The method as set forth in claim 18, wherein the physical action includes causing a machine to print an object label on the object.

20. The method as set forth in claim 18, wherein the physical action includes causing a machine to move the object into a bin.

21. The method as set forth in claim 17, further comprising an act of iteratively activating input neurons and hidden neurons until stabilization of the input neurons occurs.

22. The method as set forth in claim 21, wherein stabilization of the input neurons occurs when activations remain unchanged between two consecutive time steps or a predetermined number of iterations is performed.

23. The method as set forth in claim 17, wherein the recurrent connections include inhibitory connections.

24. The method as set forth in claim 17, wherein the signature data includes sensor recordings of the object from one or more sensors.
